(19) United States
(12) Patent Application Publication
(10) Pub. No.: US 2012/0302447 A1
(43) Pub. Date: Nov. 29, 2012

(54) MOCK COMMUNITY FOR MEASURING PYROSEQUENCING ACCURACY AND METHOD OF MEASURING PYROSEQUENCING ACCURACY USING THE SAME

(76) Inventors: Joon-Hong Park, Seoul (KR); Tae-Kwon Lee, Seoul (KR)

(21) Appl. No.: 13/401,973

(22) Filed: Feb. 22, 2012

(30) Foreign Application Priority Data
Feb. 22, 2011 (KR) 10-2011-0015756

(51) Int. Cl. C40B 20/00

(52) U.S. Cl. 506/2

(57) ABSTRACT

The present invention describes a method of measurement of pyrosequencing accuracy by directly calculating sequence errors from FLX Titanium pyrosequencing using mock community, according to the present invention, sequencing errors from FLX Titanium pyrosequencing in terms of microbial diversity and classification can be measured, resulting in possible effects of filtering.

### TECHNICAL FIELD

The present invention is related to mock community for measuring pyrosequencing accuracy and a method of measuring pyrosequencing accuracy using the same. More specifically, the present invention is related to an accuracy assessment of pyrosequencing by directly measuring the errors of FLX Titanium pyrosequencing using the amplicons of mock community.

### BACKGROUND ART

Massively parallel pyrosequencing system offers a high-throughput data of microbial diversity in environmental samples. It is now possible to generate hundreds of thousands of short (100-200 nucleotide) DNA sequence reads in a few hours without conventional cloning and sanger sequencing method.

The 454/Roche Genome Sequencers are called pyrosequencers because their sequencing technology is based on the detection of pyrophosphates released during DNA synthesis. For analysis of multiple libraries, the currently available 454/Roche pyrosequencers can accommodate a certain number of independent samples, which have to be physically separated using manifolds on the sequencing medium. These separation manifolds occlude wells on the sequencing plate from accommodating bead-bound DNA template molecules, and thus restrict the number of output sequences.

To overcome these limitations, barcodes or unique DNA sequence identifiers have been used in several experimental contexts. The barcodes allows independent samples to be pooled together before sequencing. And the barcodes as an identifier or type specifier help to separate barcoded samples from pyrosequenced results in subsequent bioinformatics.

In addition, adapters which consist of forward and reverse sequences were ligated on PCR product including barcode and attach to beads on picoplate of 454 pyrosequencer for determination of sequencing direction.

It was found a systematic error in metagenomes generated by 454-based pyrosequencing that leads to an overestimation of microbial diversity. In other words, an intrinsic artifact of the 454 pyrosequencing technique leads to the artificial amplification more than 15% of the original DNA sequencing templates. It has been suggested that multiple reading from a single template occur when amplified DNA attaches to empty beads during emulsion PCR.

The analysis of 16S rRNA genes has announced an essential tool to evaluate microbial populations in diverse environment such as soil, ocean and human body for microbial ecologist.

The high-sequence conservation of 16S rRNA genes allows to identify or/and classify bacteria in various phylogenetic levels. Therefore, bacterial diversity from environments were commonly assessed with 16S rRNA genes (16S).

Bacterial diversity can be influenced by sample preparation, primer selection, and chimeric formation from PCR products. Chimeras are generated by production of hybrid sequences between multiple parent sequences. Chimeras were found to reproducibly form among independent amplifications and contributed to false perceptions of sample diversity and the false identification of novel taxa.

There are few reports on pyrosequencing such as ‘Droplet-based pyrosequencing’(US Patent Application No. 20100291578), ‘Pyrosequencing Methods and Related Compositions’(US Patent Application No. 20090325154), and ‘Methods, Primers and Kits for Quantitative Detection of JAK2 V617F Mutants Using Pyrosequencing’ (WO patent Application No. 2008060090). However, these reports do not mention about mock community for accuracy assessment of pyrosequencing. In addition, there is another previous report on a method to improve accuracy and quality of pyrosequencing (Accuracy and quality of massively parallel DNA pyrosequencing, 2007 Huse et al., licensee BioMed Central Ltd.), it does not yet describe mock community for measuring pyrosequencing accuracy.

### BRIEF DESCRIPTION OF THE DRAWINGS

FIG. 1 shows a graph illustrating the raw sequences of region 1, 2, and 6 to 8.

FIG. 2 shows a graph illustrating the initial process in pyrosequencing pipeline of RDP (Ribosomal Database Project).

FIG. 3 shows a graph illustrating the error analysis by the dynamic programming.

FIG. 4 shows a graph illustrating the overall error rate per read of 16S rRNA, bphA, and nifH.

FIG. 5 shows a graph illustrating the substitution cumulative curve of 16S rRNA, bphA, and nifH.

FIG. 6 shows a graph illustrating the error distribution of 16S rRNA.

FIG. 7 shows a graph illustrating the error distribution of bphA.

FIG. 8 shows a graph illustrating the error distribution of nifH.

FIG. 9 shows strains, genome size, and target genes of mock community used in the present invention.

FIG. 10 shows the PCR primer sequences without adapter used.

FIG. 11 shows the PCR primer sequences with adapter used.

FIGS. 12a to 12f show the DNA concentration and volume of PCR products gained from the present invention.

### DESCRIPTION OF THE PREFERRED EMBODIMENT

### Technical Problem

The aim of the present invention is to provide mock community for measuring pyrosequencing accuracy by directly measuring the sequencing error rate of the technology through comparisons between sequences of mock community generated from the invention and reference sequences and is to provide a method of measurement of pyrosequencing accuracy using the mock community.

### Technical Solution

In order to achieve the above mentioned aim to measure sequence errors from FLX Titanium pyrosequencing using metagenomic amplicons, the present invention provides a process of calculating sequence errors from pyrosequencing, a process of revealing parameters (primer, barcode, adapter) to influence the errors, a process of repeating artificial sequence, a process of revealing primer bias with regard to mismatch, barcode or adapter, and a process of determining chimeric extent and scope from mock community.

The present invention provides mock community for measuring pyrosequencing accuracy characterized by comprising Rhodospillum rubrurn ATCC 11170, Burkholderia vietarnensis G4, Burkholderia xenovorans LB400, Desulfitobacteruim hafniense DCB-2, Nostoc. PCC 7120, Polaromonas napthalenivorans CJ2, Rhodococcus sp. RHA 1, Pseudomonas putida F1, Neisseria sicca ATCC 29256, Ochrobactrum anthropi ATCC 49188, Chromobacterium violaceum ATCC 12472, Pseudomonas pickettii PKO1, Sphingobium yanoikuyae B1, Escherichia Coli K-12 sub W3110, Bacillus cents ATCC 14579, Corynebacterium glutamin ATCC 13032, Staphylococcus epidemidis ATCC 12228, Xanthomonas campestries py. ATCC 33913, Roseobacter denitrifican Och 114, and Rhodobacter sphaeroides KD 131.

In addition, the present invention provides a method for measuring pyrosequencing accuracy by comparing between sequences gained from pyrosequencing using above mock community and reference, i.e. “standard”, sequences generated from public database. To select best the standard sequences from mock community, the inventors determined the standard sequences using two methods; selection of three genes from the genome databases in NCBI and probe match using the specific primer sets with the genome databases in NCBI. All sequences were validated by HMM model of each gene to remove the unmatched sequences.

### Advantageous Effects

As described above, the present invention has effects on calculating accurate microbial diversity by providing mock community to measure directly pyrosequencing accuracy for reducing overestimated microbial diversity.

### Best Mode for the Invention

Hereinafter, the present invention will be described by the following examples in more detail. However, the purpose of these examples is only to illustrate the present invention, but not to limit the scope of the invention thereto in any way.

Experimental materials used in the present invention are shown in Table 1.

TABLE 1

| Material/Equipment | Vendor | Catalog number |
|---|---|---|
| AccuPrime ™ Taq DNA | Invitrogen | 12346-086 |
| Plymerase High Fidelity | | |
| AccuPrime ™ Pfx DNA Plymerase | Invitrogen | 12344-024 |
| Forward and Reverse Primers | Bioneer (Korea) | Custom order |
| premixed | | |
| DNAse/RNAse free water | | |
| Thermo Cycler | Biorad | C-1000 |
| Vortex | | |
| Pipettes | Eppendorf | Custom order |
| MinElute PCR Purification Kit | Qiagen | 28004 |
| QIAquick PCR Purification Kit | Qiagen | 28106 |
| Nanodrop Spectrophotometer | Thermo Scientific | ND-1000 |
| PowerSoil DNA Isolation Kit | MoBio | 12888 |
| MinElute PCR Purification Kit | | |
| Manual | | |

Polymerase Chain Reaction (PCR) was performed with AccuPrime™ Taq DNA Polymerase High Fidelity or AccuPrime™ Pfx DNA Polymerase. The present invention tested nifH, bphA, and 16S rRNA gene(27F/518R) as functional target genes.

### Example 1

### Primer Setup for PCR

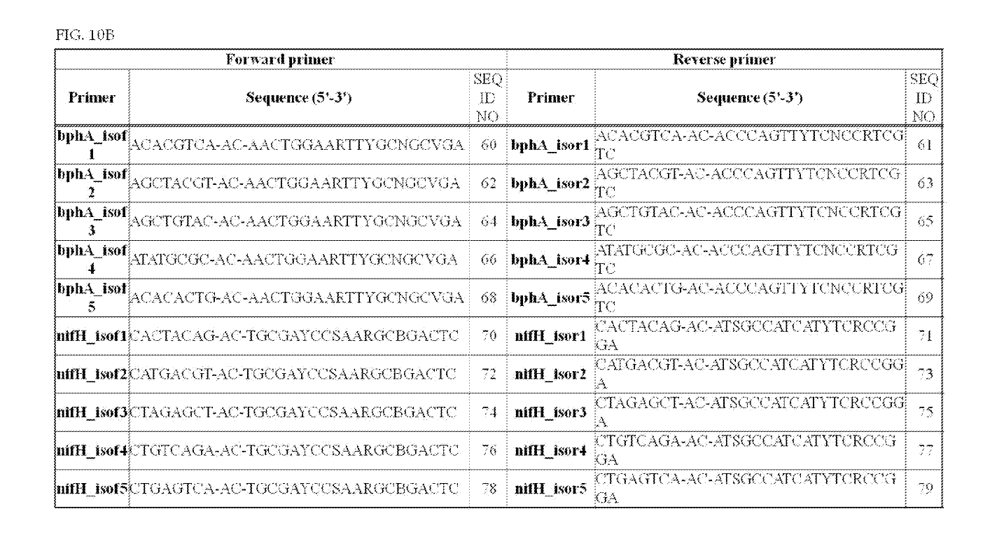

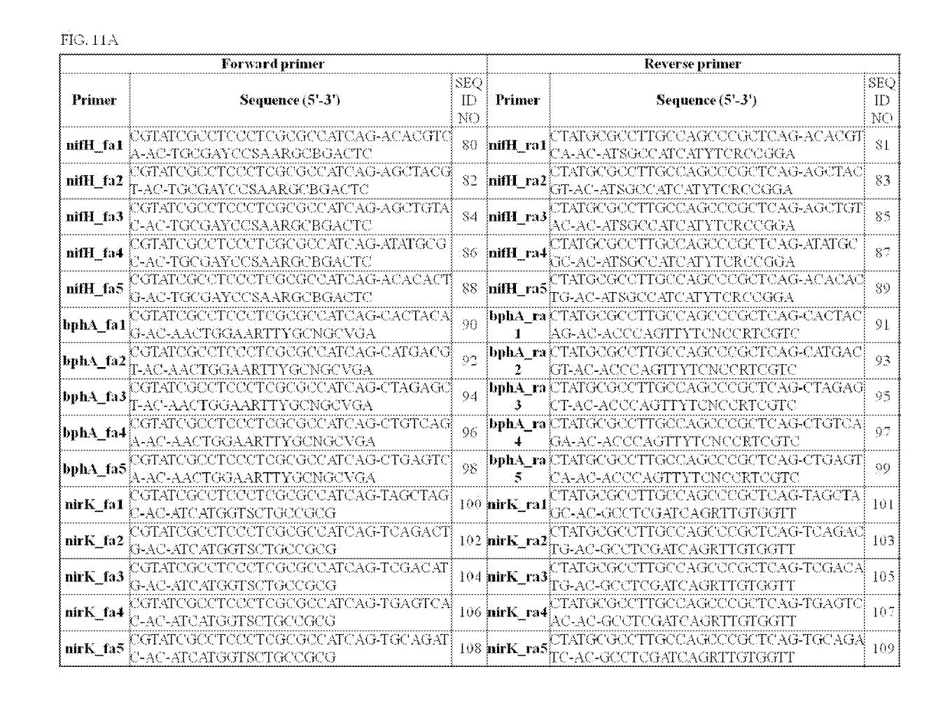

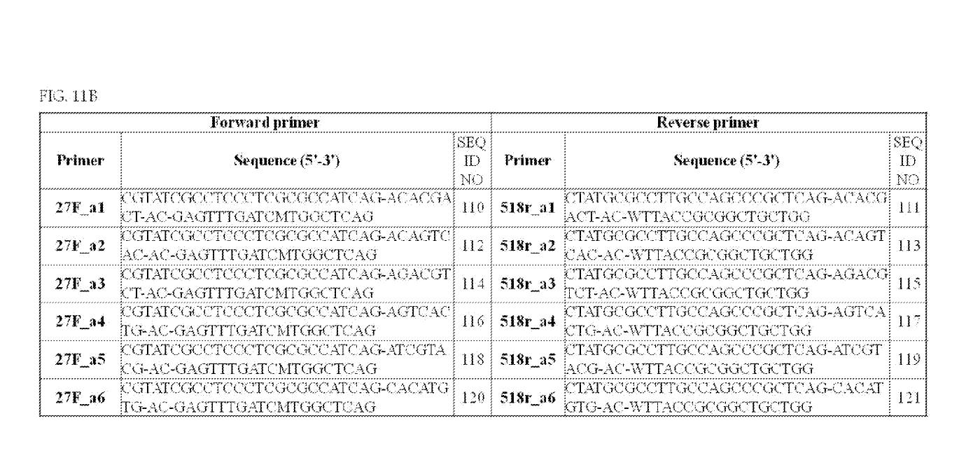

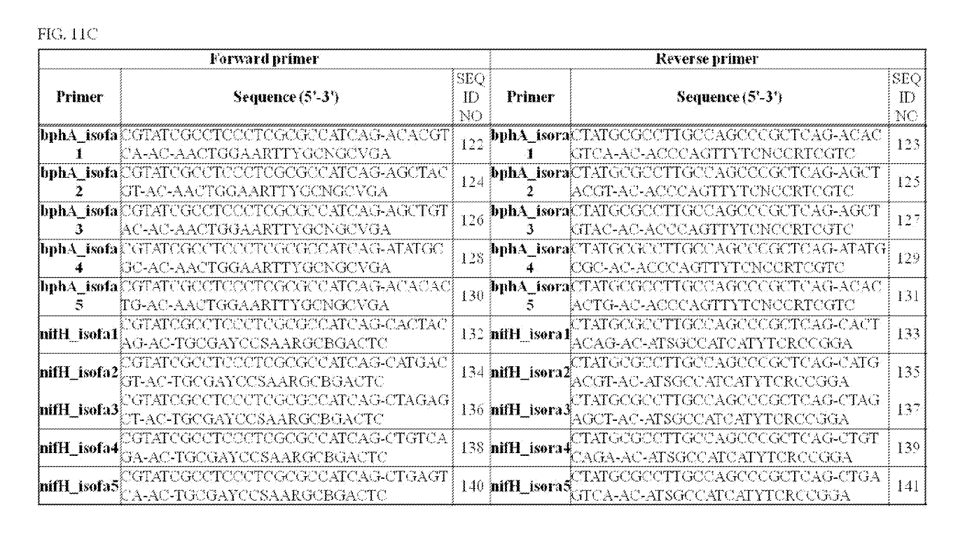

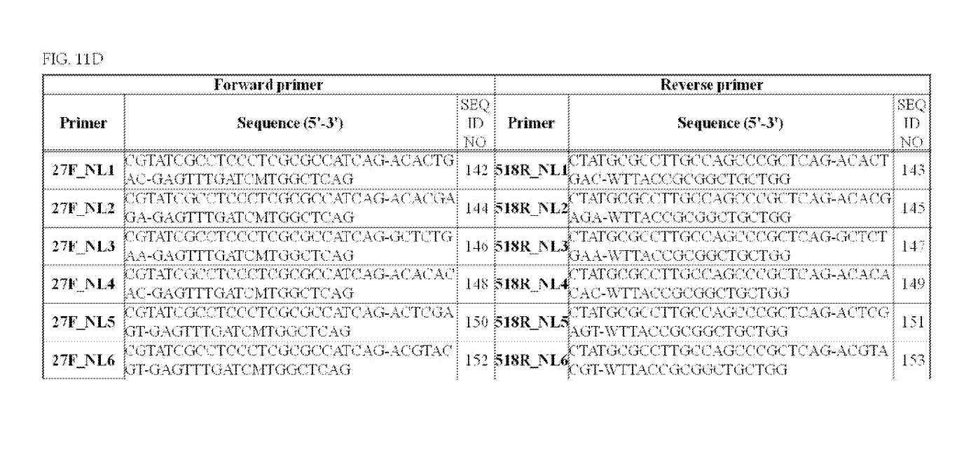

As shown below, two kinds of primer sets are designed for PCR process and the primer sequences used are listed in FIG. 10 and FIG. 11.

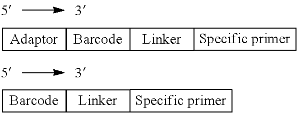

Table 2 shows the sequences of specific primers of the target genes used in the present invention.

TABLE 2

| Target | | | | |
|---|---|---|---|---|
| Gene | Primer name | Sequences (5' → 3') | Reference | Size |
| nifH | Poly Forward | TGCGAYCCSAARGCBGACTC | Poly et al. Res. | 360 bps |
| | Poly Reverse | ATSGCCATCATYTCRCCGGA | Microbiol. 2001 | |
| bph4 | BPHD-f3 | AACTGGAARTTYGCNGCVGA | Shoko et al. ISME J. 2009 | 542 bps |
| | BPHD-r1 | ACCCAGTTYTCNCCRTCGTC | | |
| nirK | F1aCu | ATCATGGTSCTGCCGCG | Michotey et al. Appl. | 472 bps |
| | R3Cu-GC | GCCTCGATCAGRTTGTGGTT | Environ. Microbiol. 2000 | |
| 16S rRNA | 27F | GAGTTTGATCMTGGCTCAG | | 492 bps |
| | 518R | WTTACCGCGGCTGCTGG | | |

### Example 2

### DNA Template Preparation

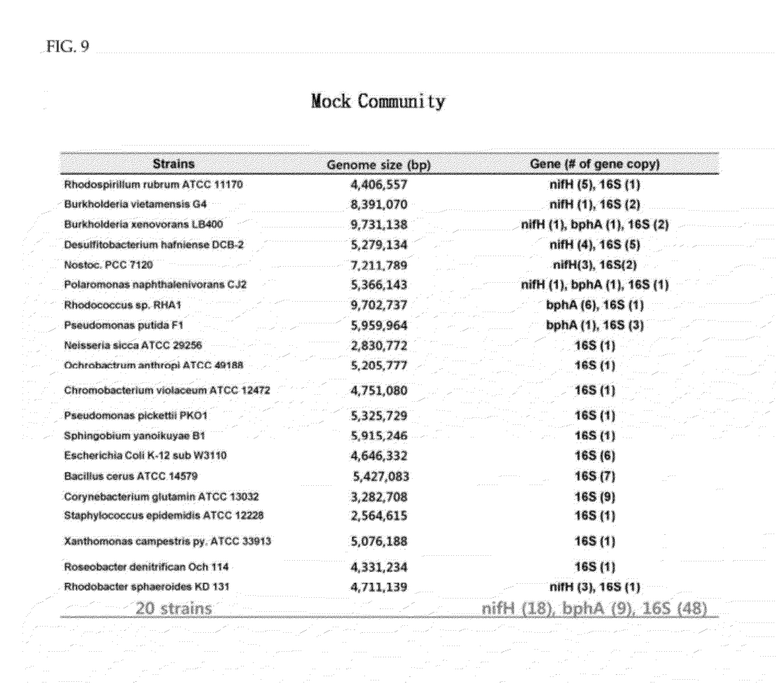

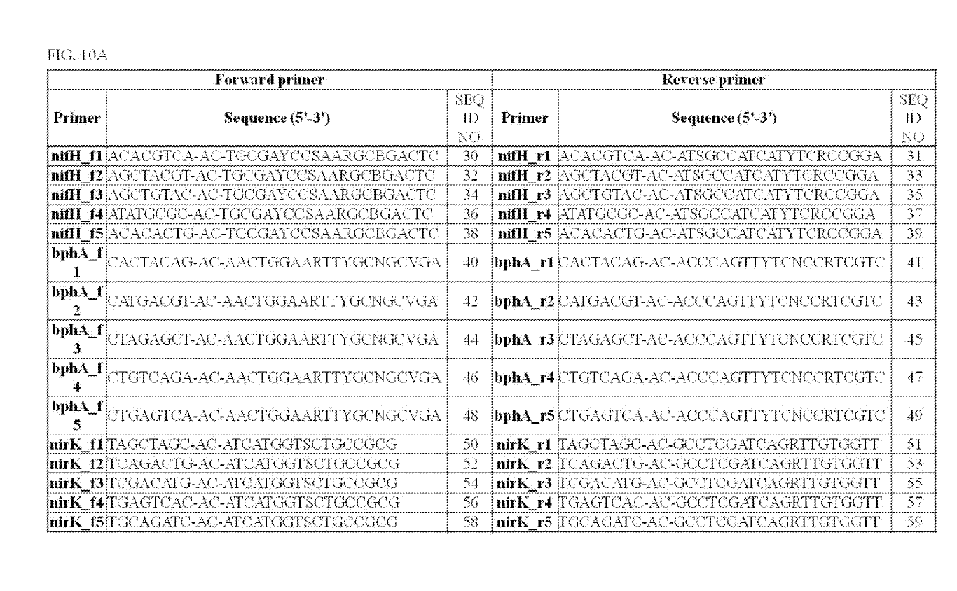

The inventor used 20 bacterial strains of mock community for template preparation as shown on FIG. 9. Genomic DNA isolated from the bacterial strains was quantified by nanodrop spectrophotometers and the mock community was prepared by mixing equal amount of each genomic DNA (Table 3).

TABLE 3

| | (gram) [symbol] | | #of | | Mismatch | | (ng/ul)/ |
|---|---|---|---|---|---|---|---|
| Gene | [symbol] | Prepared Strains (20 strains) | 16S | GC % | For | Rev | (260/280) |
| nifH | (−)Cyano* | Anabaena sp. PCC 9109 | ? | | 1 | — | 157/2.00 |
| ** | (−)Beta | Burkholderia vietnamensis G4 | 6 | 66 | 0 | 1 | 158/1.91 |
| | (−)Beta | Burkholderia xenovorans LB400 | 6 | 62 | 0 | 0 | 260/1.86 |
| | (−)Beta | Polaromonas naphthalenivorans CJ2 | 2 | 62 | 0 | 0 | 61/1.85 |
| | (+)Firmicute | Desulfitobacterium hafniense DCB-2 | 5 | 47 | 1 | 2 | 23/1.88 |
| | (−)Alpha | Rhodospirillum rubrum ATCC 11170 | 4 | 65 | 1 | 2 | 128/2.07 |
| bphA | (−)Beta | Burkholderia xenovorans LB400 | 6 | 62 | 0 | 0 | 260/1.86 |
| | (−)Beta | Polaromonas naphthalenivorans CJ2 | 2 | 62 | 1 | 1 | 61/1.85 |
| * | (+)Actino | Rhodococcus sp. RHA1 | 4 | 67 | 0 | 0 | 125/1.91 |
| | (−)Gamma | Pseudomonas putida F1 | 6 | 61 | 0 | 0 | 158/2.02 |
| nirK | (−)Beta | Neisseria sicca ATCC 29256 | 7 | 50 | — | — | 51/1.86 |
| | (−)Alpha | Ochrobactrum anthropi ATCC 49188 | 4 | 56 | 0 | 0 | 110/1.90 |
| | (−)Beta | Chromobacterium violaceum ATCC 12472 | 8 | 64 | — | — | 58/1.78 |
| | (−)Beta | Polaromonas naphthalenivorans CJ2 | 2 | 62 | — | — | 61/1.85 |
| 16S | (−)Gamma | Pseudomonas pickettii PKO1 | ? | | | | 272/1.9 |
| * | (−)Alpha | Sphingomonas yanoikuyae B1 | ? | | | | 23/1.95 |
| | (−)Gamma | Escherichia Coli K-12 sub W3110 | 7 | 50 | | | 56/1.81 |
| | (+)Firmicute | Bacillus cereus ATCC 14579 | 13 | 35 | | | 17/1.77 |
| | (+)Actino | Corynebacterium glutamine ATCC 13032 | 5 | 53 | | | 118/1.9 |
| * | (+)Firmicute | Staphylococcus epidermidis ATCC 12228 | 5 | 32 | | | 77/1.84 |
| | (−)Gamma | Xanthomonas campestris pv. campestris str. ATCC | 2 | 65 | | | 42/1.81 |
| | | 33913 | | | | | |
| | (−)Alpha | Roseobacter denitrificans OCh 114 | 1 | 58 | | | 85/1.91 |
| | (−)Alpha | Rhodobacter sphaeroides KD131 | 4 | 69 | | | 100/1.92 |

?: not Genome sequencing [symbol]
indicates data missing or illegible when filed

Table 4 represents samples used for natural community in the present invention.

TABLE 4

| Sample Name | Donation | Note |
|---|---|---|
| Soil 1 | MSU | Performed Illumina V4 16S |
| River sediment | Yonsei University | River sediment (Wonju-stream) |
| Tidal Flat | Yonsei University | Tidal Flat (Kangwha island) |
| BioCathode | Yonsei University | Operation 1 month in anaerobic |
| | | condition by Tuan |

### Example 3

### Preparation of 8 Regions for Pyrosequencing

For DNA pyrosequencing, 8 plates shown in Table 5 were prepared with mock community, natural community, adapter, barcode, linker, and specific primer of target genes as mentioned above. Adapter primers consisted of forward annealing sequence (CGTATCGCCTCCCTCGCGCCATCAG) and reverse annealing sequence (CTATGCGCCTTGCCAGCCCGCTCAG) as provided in Roche 454 protocols (FIG. 11).

TABLE 5
#1 Plate (region)

| | |
|---|---|
| DNA template | Mixed same ratio of gDNA from each mock and 4 |
| | natural communities |
| Primer composition | Adapter + Barcode + Linker + Specific primer |
| Target gene | nifH, bphA, nirK, 16S |

#2 Plate

| | |
|---|---|
| DNA template | Mixed same ratio of gDNA from each mock and 4 |
| | natural communities |
| Primer composition | Barcode + Linker + Specific primer |
| Target gene | nifH, bphA, nirK, 16S |

#3 Plate

| | |
|---|---|
| DNA template | Mixed 5 different ratio of gDNA from mock |
| | community |
| Primer composition | Adapter + Barcode + Linker + Specific primer |
| Target gene | nifH, bphA, nirK, 16S |

#4 Plate

| | |
|---|---|
| DNA template | Mixed 5 different ratio of gDNA from mock |
| | community |
| Primer composition | Barcode + Linker + Specific primer |
| Target gene | nifH, bphA, nirK, 16S |

#5 Plate

| | |
|---|---|
| DNA template | Individual gDNA from the strains with those |
| | particular genes |
| Primer composition | Adapter + Barcode + Linker + Specific primer |
| Target gene | nifH, bphA, nirK, 16S |

#6 Plate

| | |
|---|---|
| DNA template | Mixed 5 different ratio of gDNA from mock |
| | community |
| Primer composition | Adapter + Switched Barcode + Linker + Specific |
| | primer |
| Target gene | nifH, bphA |
| DNA template | Mixed 6 different ratio of gDNA from mock and |
| | natural community |
| Primer composition | Adapter + Barcode + Linker + Specific primer |
| Target gene | 16S rRNA |

#7 Plate

Replicate of #1

#8 Plate

Replicate of #2

The ratio of mock to natural community of plate #6 is shown in Table 6.

TABLE 6

| Natural | Ratio 1 | Ratio 2 | Ratio 3 |
|---|---|---|---|
| Soil 1 | 0.3:9 | 1:9 | 3:9 |
| | Ratio 4 | Ratio 5 | Ratio 6 |
| Biocathod | 0.3:9 | 1:9 | 3:9 |

Table 7 represents barcoded primer set of plate #1, #2, #7, and #8.

TABLE 7

| Target gene | Mock Community | Soil 1 | Soil 2 | Tidal flat | BioCathode |
|---|---|---|---|---|---|
| nifH | BC1 | BC2 | BC3 | BC4 | BC5 |
| bphA | BC6 | BC7 | BC8 | BC9 | BC10 |
| nirK | BC11 | BC12 | BC13 | BC14 | BC15 |
| 16S rRNA | BC16 | BC17 | BC18 | BC19 | BC20 |

Barcoded primer set of plate #3 and #4 is represented in Table 8.

TABLE 8

| Target gene | Ratio 1 | Ratio 2 | Ratio 3 | Ratio 4 | Ratio 5 |
|---|---|---|---|---|---|
| nifH | BC1 | BC2 | BC3 | BC4 | BC5 |
| bphA | BC6 | BC7 | BC8 | BC9 | BC10 |
| nirK | BC11 | BC12 | BC13 | BC14 | BC15 |
| 16S rRNA | BC16 | BC17 | BC18 | BC19 | BC20 |

Barcoded primer set of plate #5 is represented in Table 9.

TABLE 9

| Target gene | Strain 1 | Strain 2 | Strain 3 | Strain 4 | Strain 5 |
|---|---|---|---|---|---|
| nifH | BC1 | BC2 | BC3 | BC4 | BC5 |
| bphA | BC6 | BC7 | BC8 | BC9 | BC10 |
| nirK | BC11 | BC12 | BC13 | BC14 | BC15 |

| | |
|---|---|
| 16S rRNA | 5 Representative strains will be amplified with BC16-BC20 |

Table 10 represents barcoded primer set for plate #6.

TABLE 10

| | | | | | |
|---|---|---|---|---|---|
| Target gene | Ratio 1 | Ratio 2 | Ratio 3 | Ratio 4 | Ratio 5 |
| nifH | BC6 | BC7 | BC8 | BC9 | BC10 |
| bphA | BC1 | BC2 | BC3 | BC4 | BC5 |
| Target gene | Ratio 1 | Ratio 2 | Ratio 3 | Ratio 4 | Ratio 5 |
| 16S rRNA | BC16 | BC17 | BC18 | BC19 | BC20 |
| | Ratio 6 | | | | |

| | |
|---|---|
| BC21 | More depth sequencing than others |

The barcoded primers used from Table 7 to Table 10 are 8 nucleotides long and the sequences are listed in Table 11.

TABLE 11

| Barcode | Sequence | Barcode | Sequence | Barcode | Sequence |
|---|---|---|---|---|---|
| BC1 | ACACGTCA | BC8 | CTAGAGCT | BC15 | TGCAGATC |
| BC2 | AGCTACGT | BC9 | CTGTCAGA | BC16 | ACACGACT |
| BC3 | AGCTGTAC | BC10 | CTGAGTCA | BC17 | ACAGTCAC |
| BC4 | ATATGCGC | BC11 | TAGCTAGC | BC18 | AGACGTCT |
| BC5 | ACACACTG | BC12 | TCAGACTG | BC19 | AGTCACTG |
| BC6 | CACTACAG | BC13 | TCGACATG | BC20 | ATCGTACG |
| BC7 | CATGACGT | BC14 | TGAGTCAC | BC21 | CACATGTG |

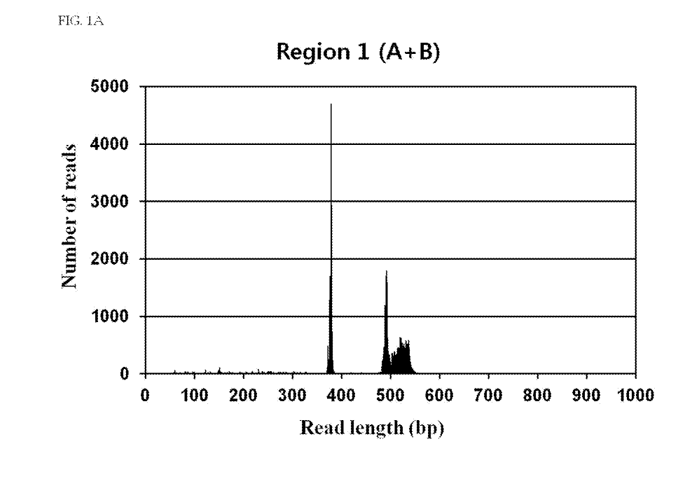

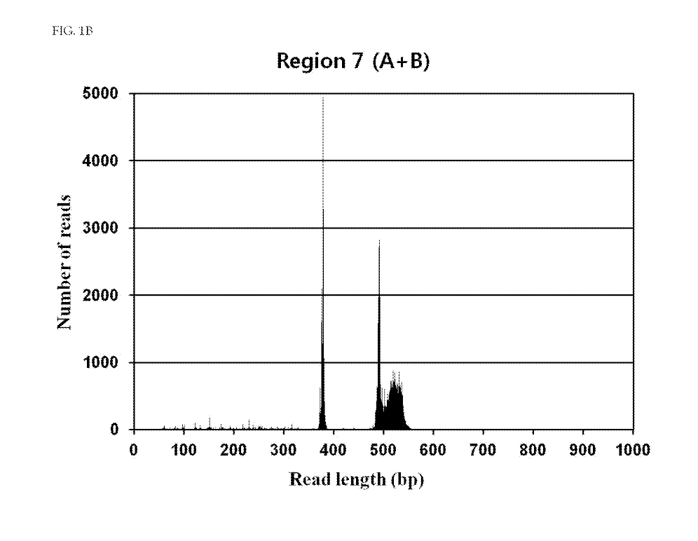

Meanwhile, FIG. 1 shows a graph illustrating raw data sequences obtained from the plate #1, #2, and #6 to #8.

### Example 4

### Master Mix Preparation for PCR

Master mix contained 2.5 ul of 10×AccuPrime PCR Buffer II, 0.2 ul of Accuprime Taq Hifi, Mixed Primer, and 60 ng of genomic DNA template with RNAse/DNAse free water in a 25-ul total volumn.

### Example 5

### Polymerase Chain Reaction

Reaction mixture obtained from the above was spin down briefly at 2000 rpm in a centrifuge, followed by PCR as shown in Table 12.

TABLE 12

| Target | | | | Target | | | |
|---|---|---|---|---|---|---|---|
| gene | Temp. | Time | Cycle | gene | Temp. | Time | Cycle |
| nifH | 94° C. | 1 min | | bphA | 95° C. | 3 min | |
| | 94° C. | 1 min | 30 Cycle | | 95° C. | 45 sec | 30 Cycle |
| | 55° C. | 1 min | | | 60° C. | 45 sec | |
| | 72° C. | 2 min | | | 72° C. | 40 sec | |
| | 72° C. | 5 min | | | 72° C. | 4 min | |
| | 4° C. | forever | | | 4° C. | forever | |
| nirK | 95° C. | 1 min | | 16S | 94° C. | 3 min | |
| | 94° C. | 1 min | 30 Cycle | | 94° C. | 30 sec | 30 Cycle |
| | 51° C. | 1 min | | | 55° C. | 30 sec | |
| | 72° C. | 1 min | | | 72° C. | 1 min | |
| | 72° C. | 10 min | | | 72° C. | 5 min | |
| | 4° C. | forever | | | 4° C. | forever | |

PCR products were purified using QIAquick PCR Purification Kit.

### Example 6

### Gel Analysis of PCR Products

1 ul of PCR product was mixed with 1 ul of 10× loading dye and 8 ul of distilled water on parafilm by pipetting. 1% agarose gel with 1×TAE was prepared by SaFeview. After loading each PCR product into the gel, electrophoresis was run approximately 1 hour at 100V, followed by visualization on gel-doc and analysis.

### Example 7

### Quantification of PCR Products

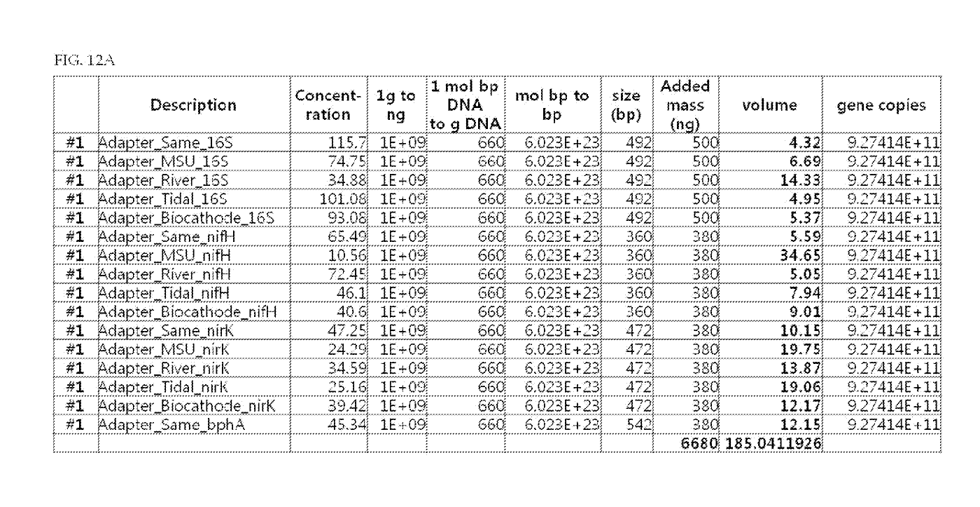

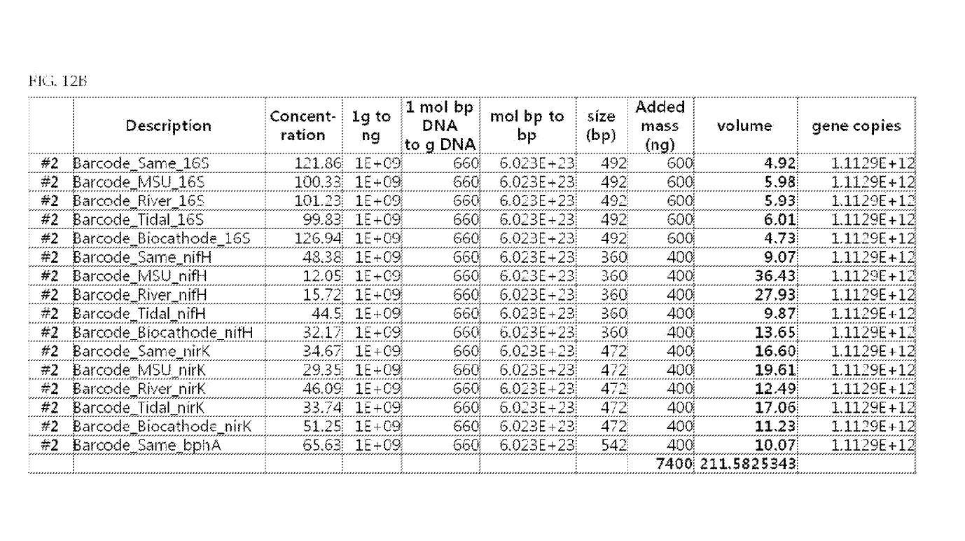

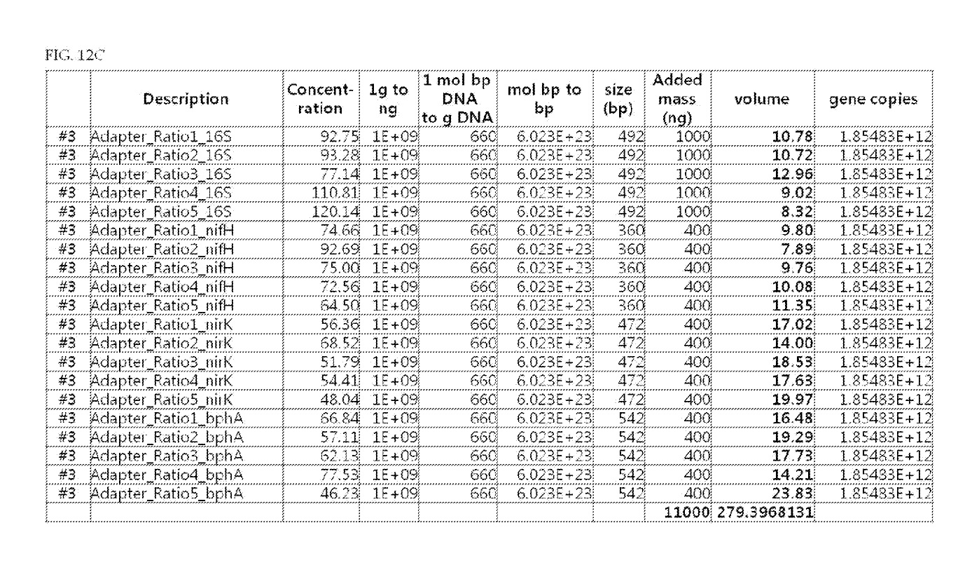

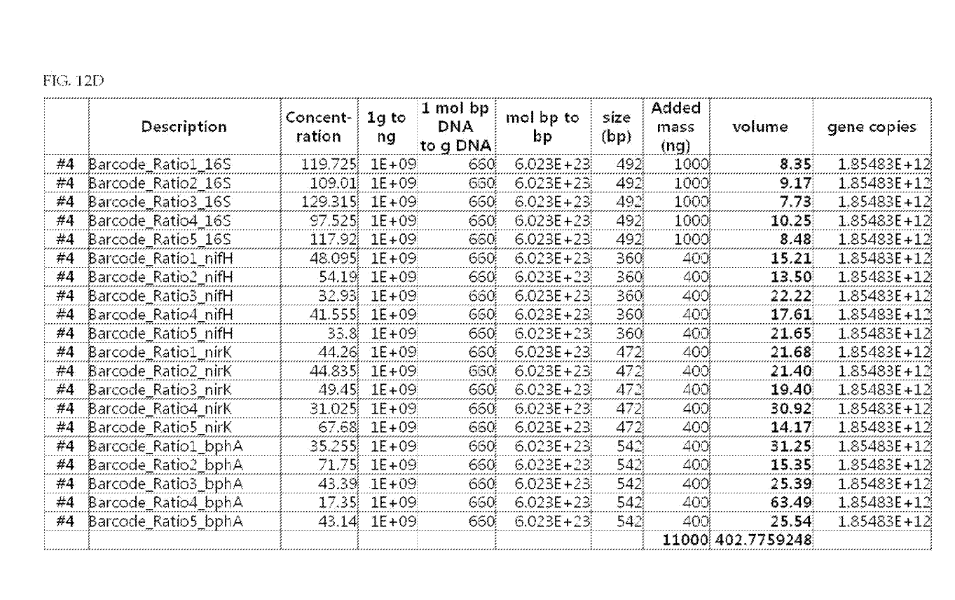

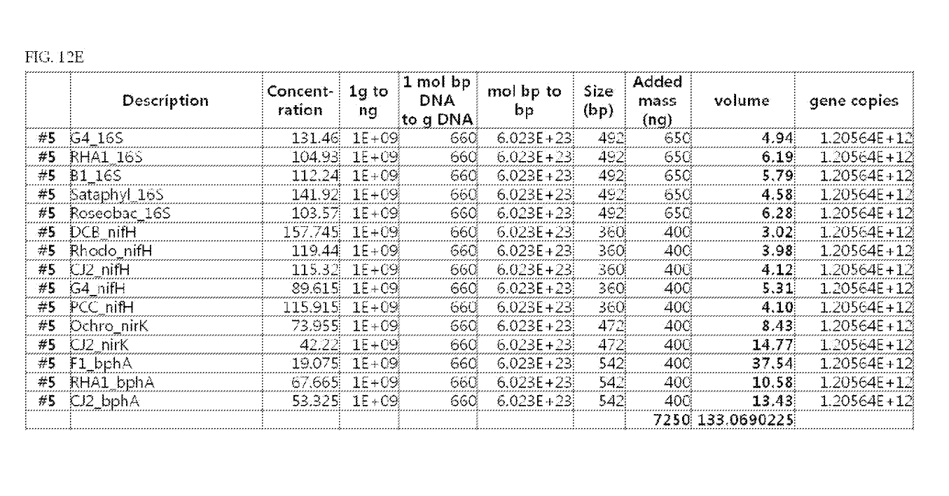

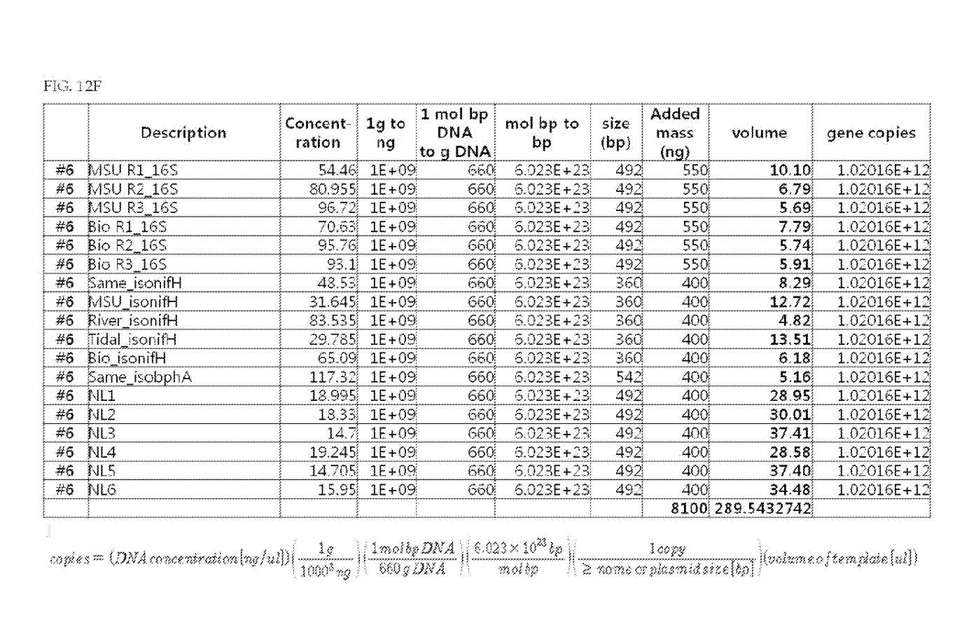

Quantification of PCR products was determined by nanodrop spectrophotometer according to the manufacture's instruction and the results obtained are shown as concentration in FIGS. 12a to 12f.

### Example 8

### PCR Pooling

From the results of nanodrop spectrophotometer above, pooling amounts were calculated by pooling Calculator.xls or formula as follows:

Amount (ul) of each sample=((vol/2)*(min))/sampleconc

Where Vol is the total volume of each sample, Min is the concentration in ng/ul of the sample with the lowest concentration, and Sampleconc is the concentration in ng/ul of target sample.

Samples were pooled by 1 ul of a minimum transfer volume. Sample was diluted if less than 1 ul was required.

To purify the pool gained from the above, Qiagen minElute column was used according to the manufacturer's protocol. To increase the purity of samples, additional purification step was added and the results obtained were ≧1.8 at A_{260/280}.

### Example 9

### Pyrosequencing

Using the Genome Sequencing FLX Titanium pyrosequencing (Roche), according to the manufacture's instruction, sequencing was carried out at Macrogen Incorporation, Korea.

### Example 10

### Standard Sequencing Collection

In order to collect the optimal DNA sequences from the mock community, the inventor selected standard sequences in two ways. Three target genes including nifH, bphA, and 16S rRNA Were selected from the NCBI genome database and their specific primers were used to identify probe match. To remove mismatch sequences, all of the DNA sequences were aligned to each target gene based on the Hidden Markov Model (HMM).

### Example 11

### Initial Processing

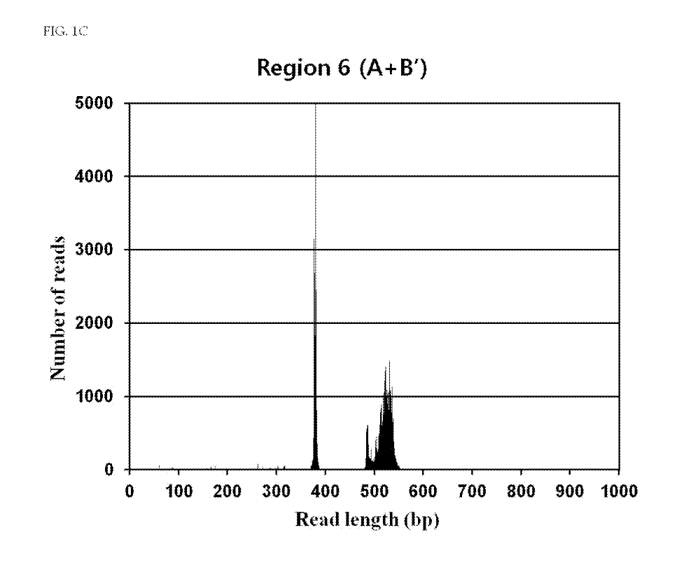

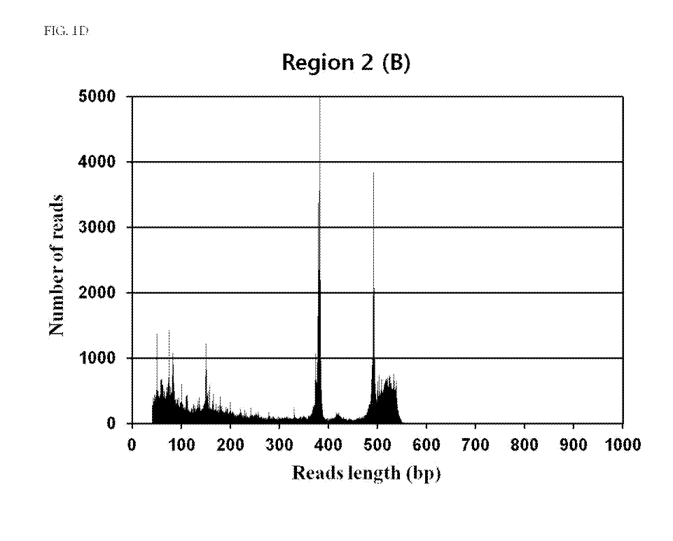

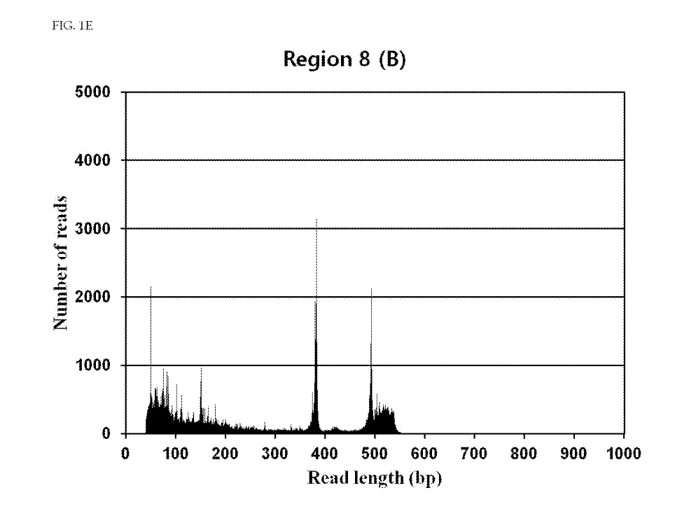

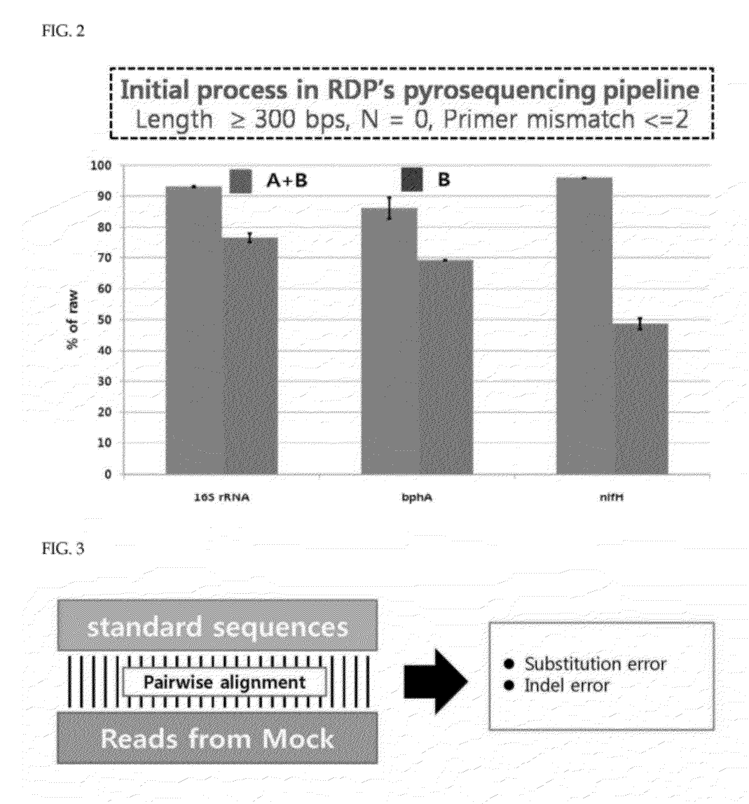

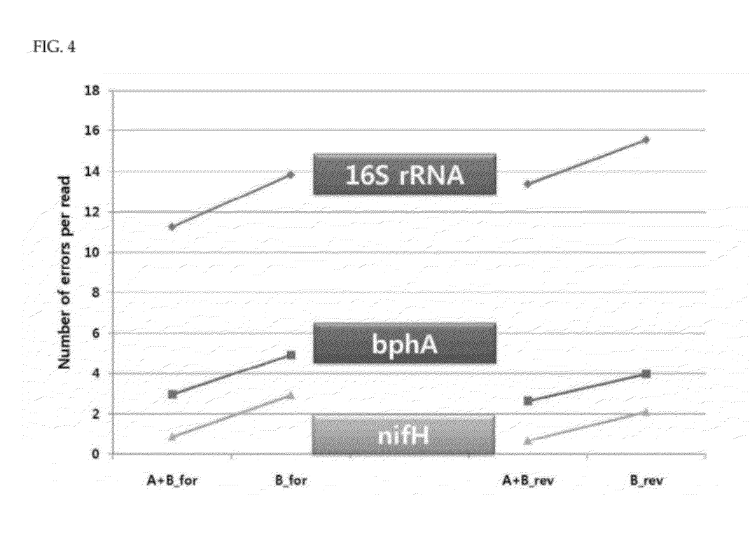

In order to acquire good quality sequences, the sequences which showed ≧2 for forward primer mismatch or ≧0 for average exponential quality score were filtered through the RDP Pyro Initial Process tool [Cole, etc., 2009]. The bases prior to the forward primer were cut off from reads. Because of the long reads, the reverse primer was not validated for 16S and bphA. In the case of nifH reads, the reverse primer should be a perfect match and the reverse primer was cut off. After ambiguous bases or trimming process, read length less than 300 bps were cut off as well (FIG. 2).

### Example 12

### Contaminated Sequence Detection

Reads that passed the initial quality process were analyzed by specifically designed RDP tool ContaminateBot. Using RDP Seqmatch tool, reads were compared to the high-quality RDP public dataset and the mock community sequences. Reads that the difference of S_ab score was more than 0.2 and the sequences was closer to the RDP public dataset than the mock community were considered to be contaminated sequences, thus removed.

### Example 13

### Chimera Detection

To discriminate potential chimera, reads that error rate was more than 3% were analyzed with specifically designed RDP tool ChimeraBot. This tool made partial alignments from 5′- or 3′-sequences relative to standard mock community sequences per individual read. Through the forward and the reverse alignment, the present invention acquired information such as maximum score of all possible combinations, mock community parents, and alignment breakpoint. As the total score was at least 10% higher than the score of optimal single-parent alignment and individual partial alignment was 95% identity, the reads were assumed to be potential chimera, therefore removed from the error calculation.

### Example 14

### Error Analysis

The non-contaminant reads that passed the initial quality process were compared to the standard sequences of the mock community using RDP mock community analysis tool (http://pyro.cme.msu.edu/). Individual read calculated alignment between the standard sequences of the mock community and gained standard sequences with high similarity relative to the optimal alignment. Based on the optimal alignment, indel and mismatch errors were calculated (FIG. 3).

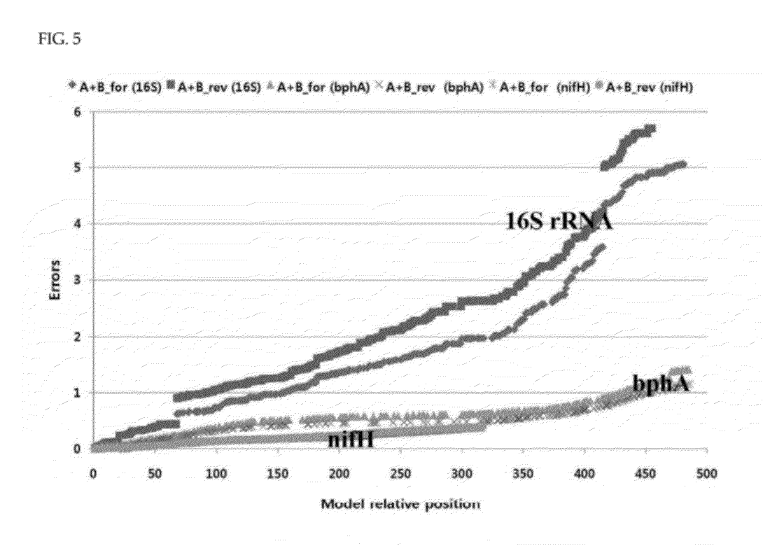

Overall error rates were measured by dividing the total results of the indel and mismatch to the sequence results of pyrosequencing of each gene (barcode+adapter/barcode/direction), and the difference for sequencing direction was identified by mismatch cumulative curve (FIG. 5).

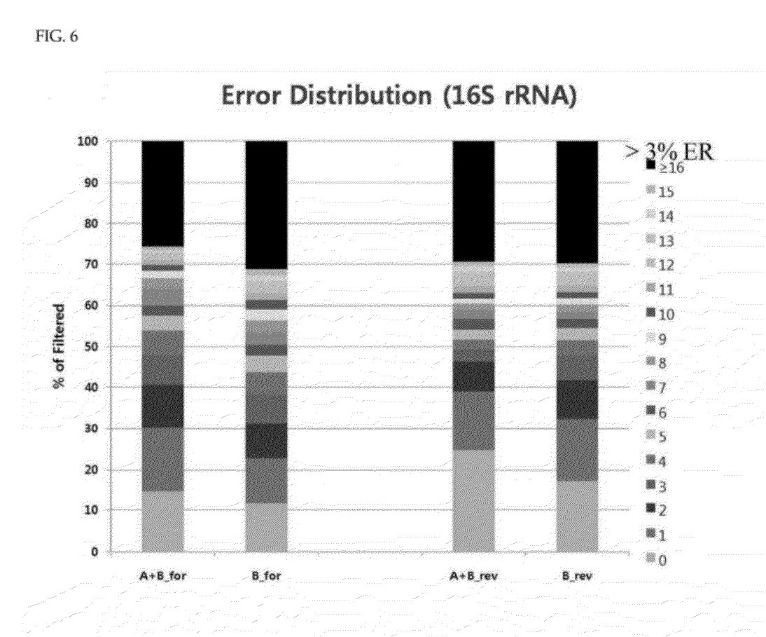

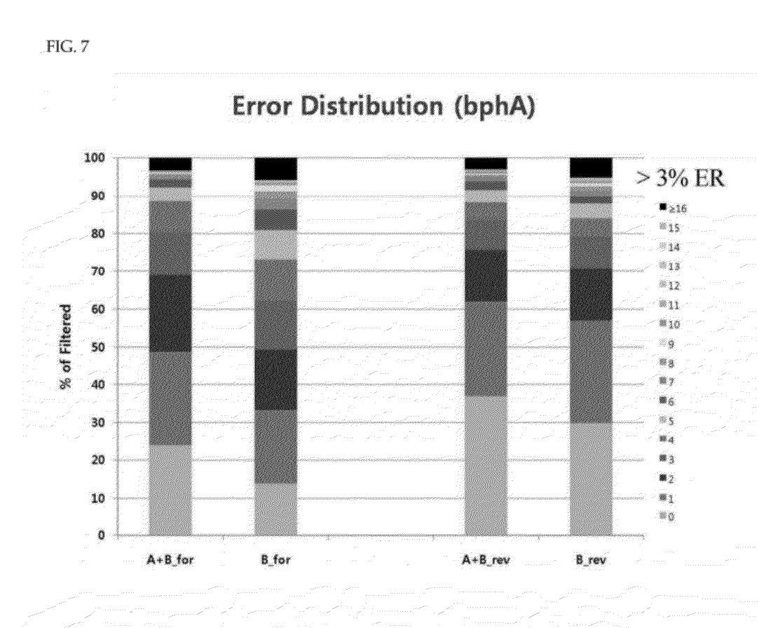

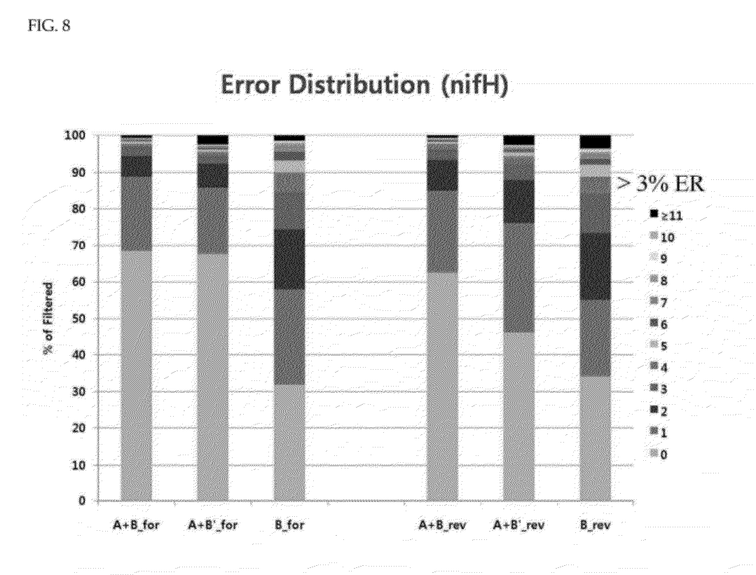

In order to understand the distribution on the error number of each gene, the cumulative error distribution was illustrated in FIG. 6 to FIG. 8.

Having thus described the invention, there is claimed as new and desired to be secured by Letters Patent:

1. A mock community for measuring pyrosequencing accuracy characterized by comprising Rhodospillum rubrum ATCC 11170, Burkholderia vietamensis G4, Burkholderia xenovorans LB400, Desulfitobacteruim hafniense DCB-2, Nostoc. PCC 7120, Polaromonas naphthalenivorans CJ2, Rhodococcus sp. RHA 1, Pseudomonas putida F1, Neisseria sicca ATCC 29256, Othrobactrum anthropi ATCC 49188, Chromobacterium violaceum ATCC 12472, Pseudomonas pickettii PKO1, Sphingobium yanoikuyae B1, Escherichia Coli K-12 sub W3110, Bacillus cerus ATCC 14579, Corynebacterium glutamin ATCC 13032, Staphylococcus epidemidis ATCC 12228, Xanthomonas campestries py. ATCC 33913, Roseobacter denitrifican Och 114, and Rhodobacter sphaeroides KD 131.

2. A method for measuring pyrosequencing accuracy by comparing the pyrosequencing results from the mock community of claim 1 with reference sequences of the mock community.

3. A method for measuring pyrosequencing accuracy in accordance with claim 2, wherein the reference sequences comprise three target genes selected from the genome databases in NCBI, the three target genes comprising nifH, bphA and 16S rRNA.

4. A method for measuring pyrosequencing accuracy in accordance with claim 3, wherein the step of comparing includes using specific primer sets for identifying a probe match between said genes and the pyrosequencing results from the mock community.

5. A method for measuring pyrosequencing accuracy in accordance with claim 4, further including the step of aligning the DNA sequences of the pyrosequencing results with the respective target genes based on the HHM model and removing any resulting mismatch sequences.

6. A method for measuring pyrosequencing accuracy in accordance with claim 2, wherein the step of comparing includes using specific primer sets for identifying a probe match between the reference sequences and the pyrosequencing results from the mock community.

7. A method for measuring pyrosequencing accuracy in accordance with claim 6, wherein the step of comparing includes aligning the DNA sequences of the pyrosequencing results with the reference sequences of the mock community, and removing any resulting mismatch sequences.


SEQUENCE LISTING (153 sequences)

SEQ ID NO: 1 - DNA, 20 bp, Burkholderia xenovorans
tgcgayccsaargcbgactc

SEQ ID NO: 2 - DNA, 20 bp, Burkholderia xenovorans
atsgccatcatytcrccgga

SEQ ID NO: 3 - DNA, 20 bp, Burkholderia xenovorans
  misc_feature (15)..(15): n is a, c, g, or t
aactggaarttygcngcvga

SEQ ID NO: 4 - DNA, 20 bp, Burkholderia xenovorans
  misc_feature (12)..(12): n is a, c, g, or t
acccagttytcnccrtcgtc

SEQ ID NO: 5 - DNA, 17 bp, Polaromonas naphthalenivorans
atcatggtsctgccgcg

SEQ ID NO: 6 - DNA, 20 bp, Polaromonas naphthalenivorans
gcctcgatcagrttgtggtt

SEQ ID NO: 7 - DNA, 19 bp, Escherichia coli
gagtttgatcmtggctcag

SEQ ID NO: 8 - DNA, 17 bp, Escherichia coli
wttaccgcggctgctgg

SEQ ID NO: 9 - DNA, 8 bp, Artificial sequence
  synthesized sequence
acacgtca

SEQ ID NO: 10 - DNA, 8 bp, Artificial sequence
  synthesized sequence
agctacgt

SEQ ID NO: 11 - DNA, 8 bp, Artificial sequence
  synthesized sequence
agctgtac

SEQ ID NO: 12 - DNA, 8 bp, Artificial sequence
  synthesized sequence
atatgcgc

SEQ ID NO: 13 - DNA, 8 bp, Artificial sequence
  synthesized sequence
acacactg

SEQ ID NO: 14 - DNA, 8 bp, Artificial sequence
  synthesized sequence
cactacag

SEQ ID NO: 15 - DNA, 8 bp, Artificial sequence
  synthesized sequence
catgacgt

SEQ ID NO: 16 - DNA, 8 bp, Artificial sequence
  synthesized sequence
ctagagct

SEQ ID NO: 17 - DNA, 8 bp, Artificial sequence
  synthesized sequence
ctgtcaga

SEQ ID NO: 18 - DNA, 8 bp, Artificial sequence
  synthesized sequence
ctgagtca

SEQ ID NO: 19 - DNA, 8 bp, Artificial sequence
  synthesized sequence
tagctagc

SEQ ID NO: 20 - DNA, 8 bp, Artificial sequence
  synthesized sequence
tcagactg

SEQ ID NO: 21 - DNA, 8 bp, Artificial sequence
  synthesized sequence
tcgacatg

SEQ ID NO: 22 - DNA, 8 bp, Artificial sequence
  synthesized sequence
tgagtcac

SEQ ID NO: 23 - DNA, 8 bp, Artificial sequence
  synthesized sequence
tgcagatc

SEQ ID NO: 24 - DNA, 8 bp, Artificial sequence
  synthesized sequence
acacgact

SEQ ID NO: 25 - DNA, 8 bp, Artificial sequence
  synthesized sequence
acagtcac

SEQ ID NO: 26 - DNA, 8 bp, Artificial sequence
  synthesized sequence
agacgtct

SEQ ID NO: 27 - DNA, 8 bp, Artificial sequence
  synthesized sequence
agtcactg

SEQ ID NO: 28 - DNA, 8 bp, Artificial sequence
  synthesized sequence
atcgtacg

SEQ ID NO: 29 - DNA, 8 bp, Artificial sequence
  synthesized sequence
cacatgtg

SEQ ID NO: 30 - DNA, 30 bp, Burkholderia xenovorans
acacgtcaactgcgayccsaargcbgactc

SEQ ID NO: 31 - DNA, 30 bp, Burkholderia xenovorans
acacgtcaacatsgccatcatytcrccgga

SEQ ID NO: 32 - DNA, 30 bp, Burkholderia xenovorans
agctacgtactgcgayccsaargcbgactc

SEQ ID NO: 33 - DNA, 30 bp, Burkholderia xenovorans
agctacgtacatsgccatcatytcrccgga

SEQ ID NO: 34 - DNA, 30 bp, Burkholderia xenovorans
agctgtacactgcgayccsaargcbgactc

SEQ ID NO: 35 - DNA, 30 bp, Burkholderia xenovorans
agctgtacacatsgccatcatytcrccgga

SEQ ID NO: 36 - DNA, 30 bp, Burkholderia xenovorans
atatgcgcactgcgayccsaargcbgactc

SEQ ID NO: 37 - DNA, 30 bp, Burkholderia xenovorans
atatgcgcacatsgccatcatytcrccgga

SEQ ID NO: 38 - DNA, 30 bp, Burkholderia xenovorans
acacactgactgcgayccsaargcbgactc

SEQ ID NO: 39 - DNA, 30 bp, Burkholderia xenovorans
acacactgacatsgccatcatytcrccgga

SEQ ID NO: 40 - DNA, 30 bp, Burkholderia xenovorans
  misc_feature (25)..(25): n is a, c, g, or t
cactacagacaactggaarttygcngcvga

SEQ ID NO: 41 - DNA, 30 bp, Burkholderia xenovorans
  misc_feature (22)..(22): n is a, c, g, or t
cactacagacacccagttytcnccrtcgtc

SEQ ID NO: 42 - DNA, 30 bp, Burkholderia xenovorans
  misc_feature (25)..(25): n is a, c, g, or t
catgacgtacaactggaarttygcngcvga

SEQ ID NO: 43 - DNA, 30 bp, Burkholderia xenovorans
  misc_feature (22)..(22): n is a, c, g, or t
catgacgtacacccagttytcnccrtcgtc

SEQ ID NO: 44 - DNA, 30 bp, Burkholderia xenovorans
  misc_feature (25)..(25): n is a, c, g, or t
ctagagctacaactggaarttygcngcvga

SEQ ID NO: 45 - DNA, 30 bp, Burkholderia xenovorans
  misc_feature (22)..(22): n is a, c, g, or t
ctagagctacacccagttytcnccrtcgtc

SEQ ID NO: 46 - DNA, 30 bp, Burkholderia xenovorans
  misc_feature (25)..(25): n is a, c, g, or t
ctgtcagaacaactggaarttygcngcvga

SEQ ID NO: 47 - DNA, 30 bp, Burkholderia xenovorans
  misc_feature (22)..(22): n is a, c, g, or t
ctgtcagaacacccagttytcnccrtcgtc

SEQ ID NO: 48 - DNA, 30 bp, Burkholderia xenovorans
  misc_feature (25)..(25): n is a, c, g, or t
ctgagtcaacaactggaarttygcngcvga

SEQ ID NO: 49 - DNA, 30 bp, Burkholderia xenovorans
  misc_feature (22)..(22): n is a, c, g, or t
ctgagtcaacacccagttytcnccrtcgtc

SEQ ID NO: 50 - DNA, 27 bp, Polaromonas naphthalenivorans
tagctagcacatcatggtsctgccgcg

SEQ ID NO: 51 - DNA, 30 bp, Polaromonas naphthalenivorans
tagctagcacgcctcgatcagrttgtggtt

SEQ ID NO: 52 - DNA, 27 bp, Polaromonas naphthalenivorans
tcagactgacatcatggtsctgccgcg

SEQ ID NO: 53 - DNA, 30 bp, Polaromonas naphthalenivorans
tcagactgacgcctcgatcagrttgtggtt

SEQ ID NO: 54 - DNA, 27 bp, Polaromonas naphthalenivorans
tcgacatgacatcatggtsctgccgcg

SEQ ID NO: 55 - DNA, 30 bp, Polaromonas naphthalenivorans
tcgacatgacgcctcgatcagrttgtggtt

SEQ ID NO: 56 - DNA, 27 bp, Polaromonas naphthalenivorans
tgagtcacacatcatggtsctgccgcg

SEQ ID NO: 57 - DNA, 30 bp, Polaromonas naphthalenivorans
tgagtcacacgcctcgatcagrttgtggtt

SEQ ID NO: 58 - DNA, 27 bp, Polaromonas naphthalenivorans
tgcagatcacatcatggtsctgccgcg

SEQ ID NO: 59 - DNA, 30 bp, Polaromonas naphthalenivorans
tgcagatcacgcctcgatcagrttgtggtt

SEQ ID NO: 60 - DNA, 30 bp, Burkholderia xenovorans
  misc_feature (25)..(25): n is a, c, g, or t
acacgtcaacaactggaarttygcngcvga

SEQ ID NO: 61 - DNA, 30 bp, Burkholderia xenovorans
  misc_feature (22)..(22): n is a, c, g, or t
acacgtcaacacccagttytcnccrtcgtc

SEQ ID NO: 62 - DNA, 30 bp, Burkholderia xenovorans
  misc_feature (25)..(25): n is a, c, g, or t
agctacgtacaactggaarttygcngcvga

SEQ ID NO: 63 - DNA, 30 bp, Burkholderia xenovorans
  misc_feature (22)..(22): n is a, c, g, or t
agctacgtacacccagttytcnccrtcgtc

SEQ ID NO: 64 - DNA, 30 bp, Burkholderia xenovorans
  misc_feature (25)..(25): n is a, c, g, or t
agctgtacacaactggaarttygcngcvga

SEQ ID NO: 65 - DNA, 30 bp, Burkholderia xenovorans
  misc_feature (22)..(22): n is a, c, g, or t
agctgtacacacccagttytcnccrtcgtc

SEQ ID NO: 66 - DNA, 30 bp, Burkholderia xenovorans
  misc_feature (25)..(25): n is a, c, g, or t
atatgcgcacaactggaarttygcngcvga

SEQ ID NO: 67 - DNA, 30 bp, Burkholderia xenovorans
  misc_feature (22)..(22): n is a, c, g, or t
atatgcgcacacccagttytcnccrtcgtc

SEQ ID NO: 68 - DNA, 30 bp, Burkholderia xenovorans
  misc_feature (25)..(25): n is a, c, g, or t
acacactgacaactggaarttygcngcvga

SEQ ID NO: 69 - DNA, 30 bp, Burkholderia xenovorans
  misc_feature (22)..(22): n is a, c, g, or t
acacactgacacccagttytcnccrtcgtc

SEQ ID NO: 70 - DNA, 30 bp, Burkholderia xenovorans
cactacagactgcgayccsaargcbgactc

SEQ ID NO: 71 - DNA, 30 bp, Burkholderia xenovorans
cactacagacatsgccatcatytcrccgga

SEQ ID NO: 72 - DNA, 30 bp, Burkholderia xenovorans
catgacgtactgcgayccsaargcbgactc

SEQ ID NO: 73 - DNA, 30 bp, Burkholderia xenovorans
catgacgtacatsgccatcatytcrccgga

SEQ ID NO: 74 - DNA, 30 bp, Burkholderia xenovorans
ctagagctactgcgayccsaargcbgactc

SEQ ID NO: 75 - DNA, 30 bp, Burkholderia xenovorans
ctagagctacatsgccatcatytcrccgga

SEQ ID NO: 76 - DNA, 30 bp, Burkholderia xenovorans
ctgtcagaactgcgayccsaargcbgactc

SEQ ID NO: 77 - DNA, 30 bp, Burkholderia xenovorans
ctgtcagaacatsgccatcatytcrccgga

SEQ ID NO: 78 - DNA, 30 bp, Burkholderia xenovorans
ctgagtcaactgcgayccsaargcbgactc

SEQ ID NO: 79 - DNA, 30 bp, Burkholderia xenovorans
ctgagtcaacatsgccatcatytcrccgga

SEQ ID NO: 80 - DNA, 55 bp, Burkholderia xenovorans
cgtatcgcctccctcgcgccatcagacacgtcaactgcgayccsaargcbgactc

SEQ ID NO: 81 - DNA, 55 bp, Burkholderia xenovorans
ctatgcgccttgccagcccgctcagacacgtcaacatsgccatcatytcrccgga

SEQ ID NO: 82 - DNA, 55 bp, Burkholderia xenovorans
cgtatcgcctccctcgcgccatcagagctacgtactgcgayccsaargcbgactc

SEQ ID NO: 83 - DNA, 55 bp, Burkholderia xenovorans
ctatgcgccttgccagcccgctcagagctacgtacatsgccatcatytcrccgga

SEQ ID NO: 84 - DNA, 55 bp, Burkholderia xenovorans
cgtatcgcctccctcgcgccatcagagctgtacactgcgayccsaargcbgactc

SEQ ID NO: 85 - DNA, 55 bp, Burkholderia xenovorans
ctatgcgccttgccagcccgctcagagctgtacacatsgccatcatytcrccgga

SEQ ID NO: 86 - DNA, 55 bp, Burkholderia xenovorans
cgtatcgcctccctcgcgccatcagatatgcgcactgcgayccsaargcbgactc

SEQ ID NO: 87 - DNA, 55 bp, Burkholderia xenovorans
ctatgcgccttgccagcccgctcagatatgcgcacatsgccatcatytcrccgga

SEQ ID NO: 88 - DNA, 55 bp, Burkholderia xenovorans
cgtatcgcctccctcgcgccatcagacacactgactgcgayccsaargcbgactc

SEQ ID NO: 89 - DNA, 55 bp, Burkholderia xenovorans
ctatgcgccttgccagcccgctcagacacactgacatsgccatcatytcrccgga

SEQ ID NO: 90 - DNA, 55 bp, Burkholderia xenovorans
  misc_feature (50)..(50): n is a, c, g, or t
cgtatcgcctccctcgcgccatcagcactacagacaactggaarttygcngcvga

SEQ ID NO: 91 - DNA, 55 bp, Burkholderia xenovorans
  misc_feature (47)..(47): n is a, c, g, or t
ctatgcgccttgccagcccgctcagcactacagacacccagttytcnccrtcgtc

SEQ ID NO: 92 - DNA, 55 bp, Burkholderia xenovorans
  misc_feature (50)..(50): n is a, c, g, or t
cgtatcgcctccctcgcgccatcagcatgacgtacaactggaarttygcngcvga

SEQ ID NO: 93 - DNA, 55 bp, Burkholderia xenovorans
  misc_feature (47)..(47): n is a, c, g, or t
ctatgcgccttgccagcccgctcagcatgacgtacacccagttytcnccrtcgtc

SEQ ID NO: 94 - DNA, 55 bp, Burkholderia xenovorans
  misc_feature (50)..(50): n is a, c, g, or t
cgtatcgcctccctcgcgccatcagctagagctacaactggaarttygcngcvga

SEQ ID NO: 95 - DNA, 55 bp, Burkholderia xenovorans
  misc_feature (47)..(47): n is a, c, g, or t
ctatgcgccttgccagcccgctcagctagagctacacccagttytcnccrtcgtc

SEQ ID NO: 96 - DNA, 55 bp, Burkholderia xenovorans
  misc_feature (50)..(50): n is a, c, g, or t
cgtatcgcctccctcgcgccatcagctgtcagaacaactggaarttygcngcvga

SEQ ID NO: 97 - DNA, 55 bp, Burkholderia xenovorans
  misc_feature (47)..(47): n is a, c, g, or t
ctatgcgccttgccagcccgctcagctgtcagaacacccagttytcnccrtcgtc

SEQ ID NO: 98 - DNA, 55 bp, Burkholderia xenovorans
  misc_feature (50)..(50): n is a, c, g, or t
cgtatcgcctccctcgcgccatcagctgagtcaacaactggaarttygcngcvga

SEQ ID NO: 99 - DNA, 55 bp, Burkholderia xenovorans
  misc_feature (47)..(47): n is a, c, g, or t
ctatgcgccttgccagcccgctcagctgagtcaacacccagttytcnccrtcgtc

SEQ ID NO: 100 - DNA, 52 bp, Polaromonas naphthalenivorans
cgtatcgcctccctcgcgccatcagtagctagcacatcatggtsctgccgcg

SEQ ID NO: 101 - DNA, 55 bp, Polaromonas naphthalenivorans
ctatgcgccttgccagcccgctcagtagctagcacgcctcgatcagrttgtggtt

SEQ ID NO: 102 - DNA, 52 bp, Polaromonas naphthalenivorans
cgtatcgcctccctcgcgccatcagtcagactgacatcatggtsctgccgcg

SEQ ID NO: 103 - DNA, 55 bp, Polaromonas naphthalenivorans
ctatgcgccttgccagcccgctcagtcagactgacgcctcgatcagrttgtggtt

SEQ ID NO: 104 - DNA, 52 bp, Polaromonas naphthalenivorans
cgtatcgcctccctcgcgccatcagtcgacatgacatcatggtsctgccgcg

SEQ ID NO: 105 - DNA, 55 bp, Polaromonas naphthalenivorans
ctatgcgccttgccagcccgctcagtcgacatgacgcctcgatcagrttgtggtt

SEQ ID NO: 106 - DNA, 52 bp, Polaromonas naphthalenivorans
cgtatcgcctccctcgcgccatcagtgagtcacacatcatggtsctgccgcg

SEQ ID NO: 107 - DNA, 55 bp, Polaromonas naphthalenivorans
ctatgcgccttgccagcccgctcagtgagtcacacgcctcgatcagrttgtggtt

SEQ ID NO: 108 - DNA, 52 bp, Polaromonas naphthalenivorans
cgtatcgcctccctcgcgccatcagtgcagatcacatcatggtsctgccgcg

SEQ ID NO: 109 - DNA, 55 bp, Polaromonas naphthalenivorans
ctatgcgccttgccagcccgctcagtgcagatcacgcctcgatcagrttgtggtt

SEQ ID NO: 110 - DNA, 54 bp, Escherichia coli
cgtatcgcctccctcgcgccatcagacacgactacgagtttgatcmtggctcag

SEQ ID NO: 111 - DNA, 52 bp, Escherichia coli
ctatgcgccttgccagcccgctcagacacgactacwttaccgcggctgctgg

SEQ ID NO: 112 - DNA, 54 bp, Escherichia coli
cgtatcgcctccctcgcgccatcagacagtcacacgagtttgatcmtggctcag

SEQ ID NO: 113 - DNA, 52 bp, Escherichia coli
ctatgcgccttgccagcccgctcagacagtcacacwttaccgcggctgctgg

SEQ ID NO: 114 - DNA, 54 bp, Escherichia coli
cgtatcgcctccctcgcgccatcagagacgtctacgagtttgatcmtggctcag

SEQ ID NO: 115 - DNA, 52 bp, Escherichia coli
ctatgcgccttgccagcccgctcagagacgtctacwttaccgcggctgctgg

SEQ ID NO: 116 - DNA, 54 bp, Escherichia coli
cgtatcgcctccctcgcgccatcagagtcactgacgagtttgatcmtggctcag

SEQ ID NO: 117 - DNA, 52 bp, Escherichia coli
ctatgcgccttgccagcccgctcagagtcactgacwttaccgcggctgctgg

SEQ ID NO: 118 - DNA, 54 bp, Escherichia coli
cgtatcgcctccctcgcgccatcagatcgtacgacgagtttgatcmtggctcag

SEQ ID NO: 119 - DNA, 52 bp, Escherichia coli
ctatgcgccttgccagcccgctcagatcgtacgacwttaccgcggctgctgg

SEQ ID NO: 120 - DNA, 54 bp, Escherichia coli
cgtatcgcctccctcgcgccatcagcacatgtgacgagtttgatcmtggctcag

SEQ ID NO: 121 - DNA, 52 bp, Escherichia coli
ctatgcgccttgccagcccgctcagcacatgtgacwttaccgcggctgctgg

SEQ ID NO: 122 - DNA, 55 bp, Burkholderia xenovorans
  misc_feature (50)..(50): n is a, c, g, or t
cgtatcgcctccctcgcgccatcagacacgtcaacaactggaarttygcngcvga

SEQ ID NO: 123 - DNA, 55 bp, Burkholderia xenovorans
  misc_feature (47)..(47): n is a, c, g, or t
ctatgcgccttgccagcccgctcagacacgtcaacacccagttytcnccrtcgtc

SEQ ID NO: 124 - DNA, 55 bp, Burkholderia xenovorans
  misc_feature (50)..(50): n is a, c, g, or t
cgtatcgcctccctcgcgccatcagagctacgtacaactggaarttygcngcvga

SEQ ID NO: 125 - DNA, 55 bp, Burkholderia xenovorans
  misc_feature (47)..(47): n is a, c, g, or t
ctatgcgccttgccagcccgctcagagctacgtacacccagttytcnccrtcgtc

SEQ ID NO: 126 - DNA, 55 bp, Burkholderia xenovorans
  misc_feature (50)..(50): n is a, c, g, or t
cgtatcgcctccctcgcgccatcagagctgtacacaactggaarttygcngcvga

SEQ ID NO: 127 - DNA, 55 bp, Burkholderia xenovorans
  misc_feature (47)..(47): n is a, c, g, or t
ctatgcgccttgccagcccgctcagagctgtacacacccagttytcnccrtcgtc

SEQ ID NO: 128 - DNA, 55 bp, Burkholderia xenovorans
  misc_feature (50)..(50): n is a, c, g, or t
cgtatcgcctccctcgcgccatcagatatgcgcacaactggaarttygcngcvga

SEQ ID NO: 129 - DNA, 55 bp, Burkholderia xenovorans
  misc_feature (47)..(47): n is a, c, g, or t
ctatgcgccttgccagcccgctcagatatgcgcacacccagttytcnccrtcgtc

SEQ ID NO: 130 - DNA, 55 bp, Burkholderia xenovorans
  misc_feature (50)..(50): n is a, c, g, or t
cgtatcgcctccctcgcgccatcagacacactgacaactggaarttygcngcvga

SEQ ID NO: 131 - DNA, 55 bp, Burkholderia xenovorans
  misc_feature (47)..(47): n is a, c, g, or t
ctatgcgccttgccagcccgctcagacacactgacacccagttytcnccrtcgtc

SEQ ID NO: 132 - DNA, 55 bp, Burkholderia xenovorans
cgtatcgcctccctcgcgccatcagcactacagactgcgayccsaargcbgactc

SEQ ID NO: 133 - DNA, 55 bp, Burkholderia xenovorans
ctatgcgccttgccagcccgctcagcactacagacatsgccatcatytcrccgga

SEQ ID NO: 134 - DNA, 55 bp, Burkholderia xenovorans
cgtatcgcctccctcgcgccatcagcatgacgtactgcgayccsaargcbgactc

SEQ ID NO: 135 - DNA, 55 bp, Burkholderia xenovorans
ctatgcgccttgccagcccgctcagcatgacgtacatsgccatcatytcrccgga

SEQ ID NO: 136 - DNA, 55 bp, Burkholderia xenovorans
cgtatcgcctccctcgcgccatcagctagagctactgcgayccsaargcbgactc

SEQ ID NO: 137 - DNA, 55 bp, Burkholderia xenovorans
ctatgcgccttgccagcccgctcagctagagctacatsgccatcatytcrccgga

SEQ ID NO: 138 - DNA, 55 bp, Burkholderia xenovorans
cgtatcgcctccctcgcgccatcagctgtcagaactgcgayccsaargcbgactc

SEQ ID NO: 139 - DNA, 55 bp, Burkholderia xenovorans
ctatgcgccttgccagcccgctcagctgtcagaacatsgccatcatytcrccgga

SEQ ID NO: 140 - DNA, 55 bp, Burkholderia xenovorans
cgtatcgcctccctcgcgccatcagctgagtcaactgcgayccsaargcbgactc

SEQ ID NO: 141 - DNA, 55 bp, Burkholderia xenovorans
ctatgcgccttgccagcccgctcagctgagtcaacatsgccatcatytcrccgga

SEQ ID NO: 142 - DNA, 52 bp, Escherichia coli
cgtatcgcctccctcgcgccatcagacactgacgagtttgatcmtggctcag

SEQ ID NO: 143 - DNA, 50 bp, Escherichia coli
ctatgcgccttgccagcccgctcagacactgacwttaccgcggctgctgg

SEQ ID NO: 144 - DNA, 52 bp, Escherichia coli
cgtatcgcctccctcgcgccatcagacacgagagagtttgatcmtggctcag

SEQ ID NO: 145 - DNA, 50 bp, Escherichia coli
ctatgcgccttgccagcccgctcagacacgagawttaccgcggctgctgg

SEQ ID NO: 146 - DNA, 52 bp, Escherichia coli
cgtatcgcctccctcgcgccatcaggctctgaagagtttgatcmtggctcag

SEQ ID NO: 147 - DNA, 50 bp, Escherichia coli
ctatgcgccttgccagcccgctcaggctctgaawttaccgcggctgctgg

SEQ ID NO: 148 - DNA, 52 bp, Escherichia coli
cgtatcgcctccctcgcgccatcagacacacacgagtttgatcmtggctcag

SEQ ID NO: 149 - DNA, 50 bp, Escherichia coli
ctatgcgccttgccagcccgctcagacacacacwttaccgcggctgctgg

SEQ ID NO: 150 - DNA, 52 bp, Escherichia coli
cgtatcgcctccctcgcgccatcagactcgagtgagtttgatcmtggctcag

SEQ ID NO: 151 - DNA, 50 bp, Escherichia coli
ctatgcgccttgccagcccgctcagactcgagtwttaccgcggctgctgg

SEQ ID NO: 152 - DNA, 52 bp, Escherichia coli
cgtatcgcctccctcgcgccatcagacgtacgtgagtttgatcmtggctcag

SEQ ID NO: 153 - DNA, 50 bp, Escherichia coli
ctatgcgccttgccagcccgctcagacgtacgtwttaccgcggctgctgg